(19) United States
(12) Patent Application Publication
(10) Pub. No.: US 2015/0304601 A1
(43) Pub. Date: Oct. 22, 2015

(54) Image Data System

(71) Applicant: LightGeist Ltd., Edinburgh, MI (US)

(72) Inventors: Simon John Mansell Hicks, London (GB); Liza Judith Sutherland, Edinburgh (GB); David Ian Wheatley, Dundee (GB)

(21) Appl. No.: 14/592,072

(22) Filed: Jan. 8, 2015

(30) Foreign Application Priority Data
Dec. 18, 2014 (GB) 1422594.0

(51) Int. Cl. H04N 5/76; G11B 27/034; G11B 33/10; G06Q 30/06

(52) U.S. Cl. CPC H04N 5/7605; G06Q 30/0601; G11B 27/034; G11B 33/10

(57) ABSTRACT

An image data system is provided which can record user relevant image data and provide user access to the relevant image data stored on a remote server. The image data system has at least an image recording apparatus, a remote cloud server and a user interface. Image data from an area including at least one location associated with a user is obtained by a camera and a processor mechanism identifies a portion of image data relevant to the user according to pre-determined criteria, the at least one portion of image data is stored remotely to the user interface which is provided with an activation mechanism operable to enable the user remotely access the at least one section of the image data for viewing.

The present invention relates to an image data system and, in particular, to a system for image data recording, processing and delivery which using location data provides an end user with access to recorded image data relating to the end user.

Amusement parks have, for a considerable time, taken still images of ride participants and offered these photographs to the participant after the event as a souvenir.

More recently, in amusement parks, video camera systems have been provided to record video images of participants taking part on a ride. The video camera is typically mounted on the ride carriage and records the participants face, capturing the expression of the thrill and excitement of the ride which the participant experiences as the ride progresses. The personal video can then be purchased as a DVD or the like after the activity has finished.

As modern technology has progressed, there has been a decrease in the desirability of owning hard copies of images or video footage, with consumers instead wishing for still or moving image data to be available on their personal devices, for example on their mobile phone, tablet or laptop computer.

An example of a system which provides a ride participant with a personalised video relating to an experience is detailed in US2005/0062841 which describes a system of recording and distributing a multimedia presentation of an event experience such as a rollercoaster ride. In this system, cameras are mounted upon a rollercoaster carriage and record the participant during the experience of the rollercoaster ride. Additional information, including haptic information relating to the ride and physiological information relating to the participant is also recorded and synchronised with the image data. A portion of the combined multimedia data is presented to an end user device enabling the participant to decide whether to purchase the full multimedia data and, if they do make the purchase, the multimedia data is wirelessly downloaded to their device.

Similarly, participant reactions at live events such as stadium based sports matches can be recorded for posterity by fixed camera systems and provided to event attendees as a souvenir. An example of such a system is detailed in US2010/0010195 which describes a system with multiple cameras capturing video images, the images are then compressed and prepared for transmission upon request, and payment, to a user mobile device or television display. Seating data is used with ticket data to determine relevant user video data. Searchable tags relating to key points within the event, such as “goal 1” can be used to select video footage showing the participant reaction to a given key moment. As the data can be sent to a user on demand, it is necessary for the data to be significantly compressed which results in a loss of image data and thus data quality. In addition, as seating data is required to identify relevant footage, this arrangement is only useful in seated environments.

At the same time, with the proliferation of personal devices such as mobile phones and tablets which have high quality camera technology, people are increasingly taking pictures of themselves, a “selfie”, or taking short video recordings of the event they are attending, on their mobile phone. Such pictures and videos are then posted on social media profiles by people to show that they have attended a particular event or participated in a particular activity. To post this image data on a social media profile, the person must upload the image data file to the social media platform in order to share it with their friends or the public.

In areas remote from towns and cities, cellular data connections have low speed and low bandwidth. Uploading an image over a low bandwidth mobile connection, for example in a remote location, is, if successful, a slow impractical process. A differing issue is experienced by people attending events such a sporting events or concerts within cities and towns as, the large number of attendees within a small local places a significant load on the mobile phone networks. Although 3G or 4G networks are available, the bandwidth must be shared between large numbers of mobile devices and this can slow data transmission rates significantly particularly for users attempting to upload large data files such as video footage.

Another issue for users is that most mobile phone contracts have a data limit. Uploading image data to social media sites can quickly take a user up to their allowed data limit. Furthermore, uploading image data over a poor mobile phone data connection can use more data than the size of the original image data packet itself as dropped connections can require the upload to be attempted several times.

In addition, taking “selfies”, or filming footage of the event, can interrupt the flow of participating in or viewing an event as the user has to stop and make a choice to focus on taking a photograph or video. Whilst doing this, the user is distracted from the event itself and so loses out on some of the experience.

Therefore, it is an object of the present invention to obviate or mitigate at least some of the disadvantages of the prior art.

According to a first aspect of the invention there is provided an image data system comprising at least one image recording apparatus having at least one camera for obtaining image data from an area including at least one location associated with a user; a remote processor mechanism operable to access the obtained image data and identify at least one portion of image data relevant to the user according to pre-determined criteria; a storage mechanism operable to store the at least one portion of image data and an activation mechanism operable to provide user access to remotely view the at least one section of the image data held in the storage mechanism.

The image data system is provided with at least one recording apparatus for recording images of a location or group of locations where a user, or one of several users, is, or will be, situated at least temporarily. By providing criteria, such as specific location or specific time information, to a processor which accesses the image data, footage relevant to a user can be identified. Should a user wish to view the relevant footage, the user is able to actuate an activation mechanism and gain access to the image data on the storage mechanism so that relevant footage can be viewed remotely by the user.

The recording apparatus may comprise at least one camera. The camera of the recording apparatus will have a field of view which covers an area in which a user may be located.

The recording apparatus may comprise a plurality of cameras. By providing the image recording apparatus with multiple cameras either co-located within a discreet area or distributed within a defined area, image data relating to multiple potential user locations can be recorded by the image recording apparatus at any one time. A plurality of cameras can be provided to cover a larger area that one camera could, or to obtain several simultaneous image recordings of a single area, each from a different view point, this would enable multiple image data recordings to be combined or edited together to provide the at least one portion of image data for the user.

Each camera may be arranged to communicate with the recording apparatus components using wireless transmission techniques or using cabled connections.

Preferably there may be a plurality of image recording apparatus. By providing several image recording apparatus each with at least one camera, a larger, or more complex, area may be covered by the image data system.

Preferably the storage mechanism is a remote server system operable to receive the obtained image data from the at least one image recording apparatus. Provision of a remote server system enables the image recording apparatus to be moved to different remote areas where image data is to be recorded. Similarly, a remote server enables a user to access the image data from different remote locations.

The image data system may further comprise a control mechanism operable to provide a preview section of the at least one portion of image data to a user device. By providing a preview portion to a user's personal device, the user can determine whether they wish to actuate the activation mechanism which enables them to remotely access the entire relevant portion of image data.

Preferably the preview section of image data contains less data than the at least one portion of image data. By providing a preview section of image data which is compressed or edited so that it contains substantially less data than the at least one portion of image data, the preview section can be provided to the user's personal device without using a significant amount of bandwidth. By subsequently providing access to the user such that they can access the at least one portion of image data on a remote server, the use of bandwidth required by the user to view the at least one portion is minimized.

Access to the at least one portion of image data can be provided to the user via a social media interface. The system can, upon actuation by the user, post the at least one portion of image data to their personal social media timeline thus providing the user access to the image data without the need to download the image data to their personal device for storage.

User actuation may comprise the user making a payment which activates the upload of the at least one portion of image data to a social media interface. By having a user purchase mechanism to actuate access to the at least one portion of image data the image data system can be monetized.

Each image recording apparatus may further comprise at least one local processor mechanism operable to provide obtained image data with one or more data markers. Each data marker may be at least one of a time relevant data marker and a location relevant data marker. The data markers may aid the remote processor mechanism to identifying image data relevant to a user location or a temporal event for example.

The local processor mechanism may further be operable to receive command data from a user device to edit image data upon identification of a specific data marker.

The local processor mechanism may further be operable to receive command data from an external source to activate a camera to record at a pre-determined time and/or to record image data for a specific location. An external source providing command data to instruct the camera to obtain specific temporal or location image data enables to camera to obtain data only when instructed and thus minimize the use of unnecessary power, bandwidth or data storage resources.

The remote processor mechanism may be operable to receive command data from a user to edit the image data in a desired manner. Such user commands can include a request to edit the image data to include real time footage or an event, or to modify the image data to run in slow or fast motion.

The external source may be an event specific source or may be a user personal device.

A user personal device may operate as an external source to allow users to determine when they wish footage of themselves to be recorded.

A user personal device may alternatively be provided with an activation mechanism, such as a motion sensor unit, which is operable to determine that footage should be recorded when the motion sensor unit senses a predetermined motion pattern occurring. The motion sensor unit can be arranged to identify motion data which indicates that a user is moving at an event, for example dancing at a concert or jumping in celebration at a sporting event.

The motion sensor unit may be integrated within the user personal device. Alternatively, the motion sensor unit may be separate from, but in direct communication with, the user personal device.

An event specific source allows for footage to be recorded upon the direction of an event based command system that, for example, in a football game indicates goal area activity that may lead to a goal being scored. The user response to such an activity can then be recorded for subsequent provision to the user.

The image data may undergo buffering in the local processor mechanism. Short term buffering of the image data means a user can decide to retrieve image data relating to a specific event, for example the users response to the scoring of a goal, after the goal has occurred.

Preferably the image data system further comprises a user device operating mechanism. The user device operating mechanism may be provided on a personal device. By providing a user device operating mechanism on a personal device such as a mobile phone, the operating mechanism may act as a user interface between the image data system and the user enabling preview image data to be received and actuation commands to be delivered to the image data system upon request from the user.

The image recording apparatus, remote processor mechanism and storage mechanism may all be operable to communicate with one another using a wireless data transmission system. The image recording apparatus, remote processor mechanism and storage mechanism may all be operable to communicate with a user device using a wireless data transmission system. Use of wireless transmission enables communication between the components of the system to occur without any physical interconnection.

According to another aspect of the invention there is provided a method of collecting and distributing image data, recording image data relating to an area, identifying at least one location within the area associated with a user; identifying at least one portion of image data relevant to the user using predetermined identification criteria, storing the at least one portion of image data in a remote storage mechanism and, upon activation of a predetermined mechanism, providing user access to remotely view the at least one section of the image data held in the storage mechanism.

According to another aspect of the invention there is provided a user device operating mechanism operable to interface with an image data system, the operating mechanism comprising a user interface, a request mechanism operable to send a request to an image data system for image data relevant to the user, an activation mechanism which enables a user to activate provision of remote access to relevant image data and a display mechanism operable to enable a user to view the remotely access relevant image data.

By providing a user device with a mechanism which enables interaction with the image data system a user can remotely access the image data relevant to them.

Preferably, the operating mechanism further comprises a preview mechanism for receiving a portion of the relevant image data for output on the display mechanism. By providing a user with a preview of the image data it is possible to encourage users to access and share the full relevant image data.

The operating mechanism may be able to select a social media interface to which the relevant image data is provided and through which the user is able to view the relevant image data.

The social media interface may be an interface to an external social media platform. Alternatively, the social media interface may be an interface to an integrated system social media platform.

The operating mechanism may further comprise a command mechanism operable to output a command instructing the image data system of an area incorporating a location relevant to a user to be recorded.

Preferably the operating mechanism may further comprise a location determination mechanism operable to provide an image data system with location data to indicate the location of interest to a user. The location determination mechanism may be one of a variety of systems including, but not limited to, a barcode ticket system, a seated number system, a fiducial system, an audio triangulation system, a cellular data system, a visual location system or a GPS type system.

The visual location system may comprise a light code output from a user personal device camera flash mechanism.

According to another aspect of the invention, there is provided an image recording apparatus, for use in an image data system, the image recording apparatus comprising a local processor and one or more cameras. The image recording apparatus is operable to record image data of a location or group of locations wherein the image data is provided with specific location and time information such that specific image data can be retrieved upon request by a user.

According to another aspect of the invention, there is provided a user's personal device, for use with an image data system, the user's personal device comprising an user device mechanism operable to enable a user to command the image data system to record image data and an activation mechanism operable to request recorded image data to be made available for viewing.

Embodiments of the present invention will now be described, by way of example only, with reference to the accompanying drawings in which:

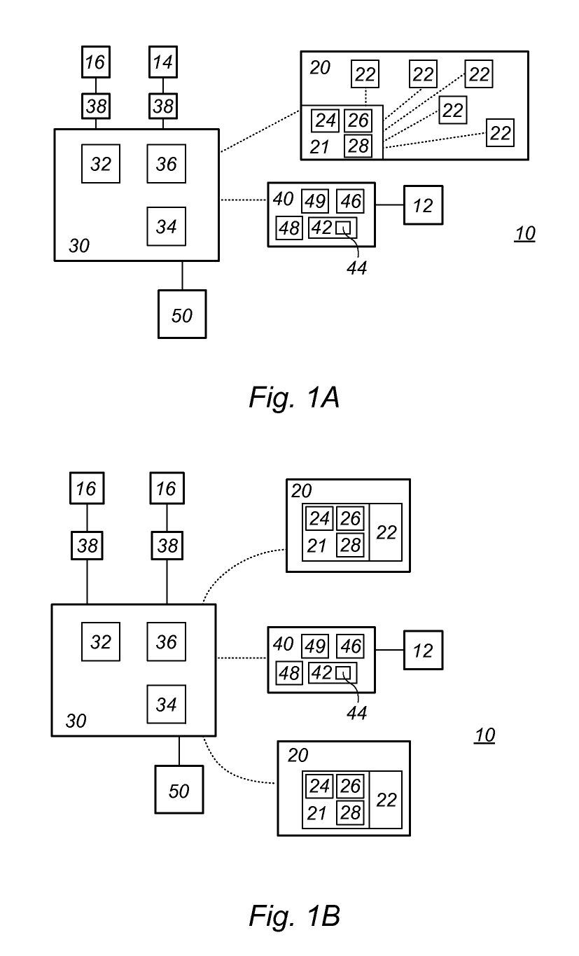

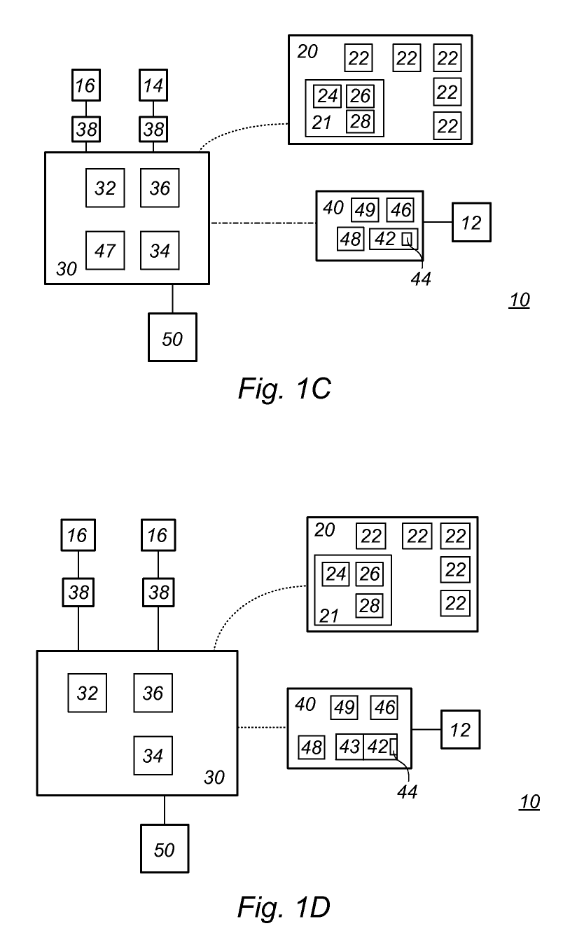

FIG. 1A is a block diagram of an image data system according to an embodiment of the present invention;

FIG. 1B is a block diagram of an image data system according to an embodiment of the present invention;

FIG. 1C is a block diagram of an image data system according to an embodiment of the present invention;

FIG. 1D is a block diagram of an image data system according to an embodiment of the present invention;

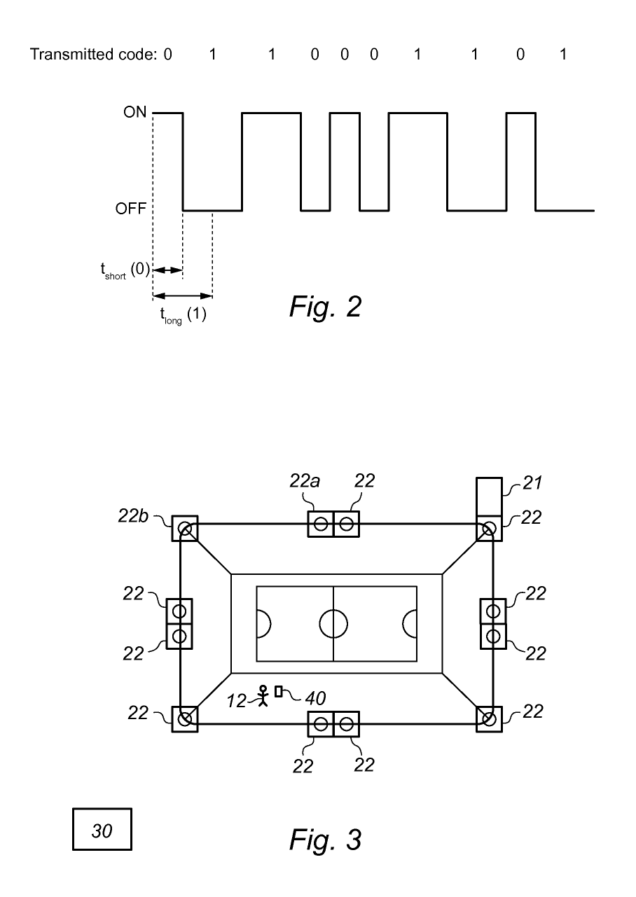

FIG. 2 is a schematic diagram of a unique code for use in a location determining mechanism of an image data system according to an embodiment of the present invention;

FIG. 3 is plan layout block diagram of components of an image data system of arranged in sports stadium according to an embodiment of the present invention;

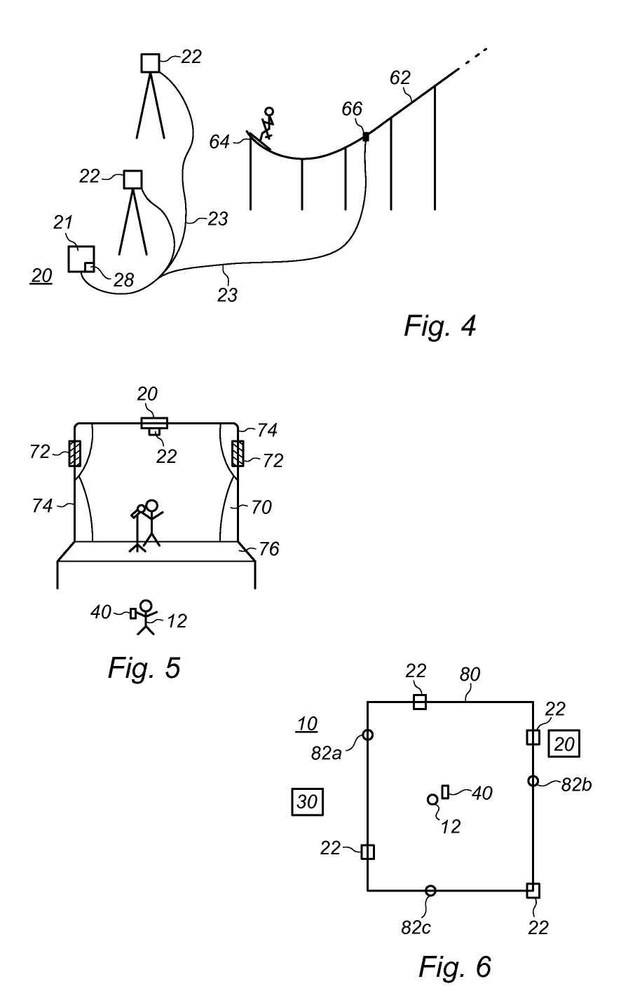

FIG. 4 is a cross section block diagram of components of an image data system arranged at a ski jump according to an embodiment of the present invention;

FIG. 5 is a front view block diagram of components of an image data system arranged at a concert venue according to an embodiment of the present invention, and

FIG. 6 is a plan view of a block diagram of components of an image data system arranged at an event venue according to an embodiment of the present invention.

Referring initially to FIG. 1A there is provided an image data system generally indicated by reference numeral 10 according to an embodiment of the present invention.

The image data system 10 is for use in recording and delivering personalised images and videos of people participating or attending an event and comprises an image recording apparatus 20 and a system cloud 30 which are operable to communicate with one another via wireless data transmission or using a cabled connection.

The image recording apparatus 20 is provided with five cameras 22, a local processor 24 a location determining mechanism 26 and a control and command unit 28. Each camera 22 is in wireless communication with the image recording apparatus hub 21, although it will be appreciated that cabled connection between each camera 22 and the hub 21 can also be used if required. Each camera 22 can record image data for the image recording apparatus 20 which will be for use in the image data system 10.

The system cloud 30 is provided with a memory 32, cloud operating mechanism 34 and cloud control mechanism 36. The processor 24 operates as an interface facilitating data transmission between system cloud 30 and the cameras 22. The processor 24 can further operate as an interface facilitating data transmission between system cloud 30 and the location determining mechanism 26. The processor 24 also operates as an interface between the location determining mechanism 26 and control and command unit 28 of the hub 21 and the cameras 22.

Additional system data including command and control data can be input into and received from the system operating mechanism 34 by an external operator 14 via an access system 38 such as a web browser. When a venue or commissioner installs the image recording apparatus 20 of image data system 10 then, depending on the location determining system being used by the image data system 10 in that specific venue, each camera 22 can be assigned to record a specific area within the camera 22 field of view. By having a single image recording apparatus, local processor 24 is able to command each camera 22 making the image recording apparatus 20 very suitable for a venue such as an arena or a sporting event occurring within a discreet area.

The commissioner operator 14 will be provided with an image data system account which enables them to access the image data system cloud 30 through the web interface 38. The access to the system cloud 30 allows the operator 14 to edit the system 10 to suit the event which they are working on and wish image data to be recorded at. The web interface 38 allows the operator 14 to view the field of view image from each camera 22 in the system 10 and ensure that all areas of the venue are covered by at least one camera.

At the location where the camera 22 is situated the camera 22 can be mounted, for example on a yoke (not shown). By mounting a camera 22 on a yoke, the angle of pan and tilt of the camera may be adjusted remotely. Additional camera features such a motorized zoom lens to adjust focal length and manual or automatic focus control can also be operated by the operator 14 through the interface 38.

With interaction from the user 12, the location determining mechanism 26 can, if necessary with assistance from cloud 30, identify the location of a user 12 within the venue and determine which camera field of view the user location is situated within to ensure relevant image data of the user 12 is obtained for later provision to the user 12.

It is also possible for additional data such as advertising data and subscriber data to be input into and received from the system cloud 30 by external third party operators 16 via an access system 38 such as a web browser.

To interact with the image data system 10, a user 12 can access system data in the system cloud 30 using a personal device 40 such as, but not limited to, a mobile phone or tablet. The personal device 40 can be provided with an operating interface 42, for example an image data system app which is able to communicate with operating mechanism 34 and exchange data bi-directionally. Relevant image data can then be provided to the user 12 either directly to the user device 40 or by provision of image data from the cloud 30 to a social media platform 50 which in this case is an external social media platform such as Facebook or Twitter.

The user device operating interface 42 can enable the user 12 to determine which video footage or still images captured by camera 22 they wish to purchase. The app 42 can also provide the user with additional image data options, for example whether they wish other image data, for example, footage of an event being attended or a friend's image data, to be combined with their own image data in the creating of a video. The user device app 42 can further be provided with editing mechanisms which enable user 12 to select options such as whether they wish the footage captured to be displayed in slow, or fast, motion for effect.

As user data is collected by the image data system 10 through use, external sources such as external third parties 16 can provide event data and advertising of activities which could be relevant to the user and the user device app 42 can act to draw attention of the user 12 to this information.

Referring to FIG. 1B there is provided another embodiment of image data system generally indicated by reference numeral 10 wherein like components are referred to by the same reference numerals as used in FIG. 1A.

In FIG. 1B, the image data system 10 is provided with two image recording apparatus 20 each having an integrated hub 21 and camera 22. Each hub 21 is provided with a processor 24, a location determining mechanism 26 and a control and command unit 28. The remainder of the system 10 as is described above with reference to FIG. 1A. The processor 24 of each image recording system operates as an interface between the location determining mechanism 26, control and command unit 28 and camera 22 as well as an interface with the cloud 30. Each image recording apparatus 20 will cover a specific area of image data recording as determined by the field of view of the associated camera 22.

Referring to FIG. 1C there is provided another embodiment of image data system generally indicated by reference numeral 10 wherein like components are referred to by the same reference numerals as used in FIG. 1A.

In FIG. 1C, the system cloud 30 has a memory 32, cloud operating mechanism 34 and cloud control mechanism 36 and an internal social media platform interface 47.

To interact with the image data system 10, a user 12 can access system data in the system cloud 30 using a personal device 40 such as, but not limited to, a mobile phone or tablet. The personal device 40 can be provided with an operating interface 42, for example an image data system app which is able to communicate with operating mechanism 34 and exchange data bi-directionally. Relevant image data can then be provided to the user 12 either directly to the user device 40 or by provision of image data from the cloud 30 to internal system social media platform 47.

The user device app 42 can then, through the system social media platform 47, provide an interface to the external social media posted videos and will identify when any friend of the user comments on the video that they have uploaded and provide notification to the user 12 of the comment.

Referring to FIG. 1D there is provided another embodiment of image data system generally indicated by reference numeral 10 wherein like components are referred to by the same reference numerals as used in FIG. 1A.

In FIG. 1D, the user personal device 40 can be provided with an operating interface 42 for example an image data system app which is able to communicate with operating mechanism 34 and exchange data bi-directionally and an activation system 43 which in this case is a motion sensor. The motion sensor 43 can communicate with user device app 42 and, in real time, activate communication with operating mechanism 34 to automatically trigger recording of image data of the user upon predetermined criteria being met. The communication between the app 42 and the cloud 30 can alternatively take place after the event with a time log of motion data activation occurring due to predetermined criteria being met can be provided to the cloud. Upon being provided with a log of activation times, the recorded and stored footage can be interrogated and the temporal data of the motion activation can be matched to the recorded data to retrieve relevant footage. Having all relevant motion activation data uploaded to the cloud 30 after the event removes the necessity for the user device 40 to continuously streaming motion data to the cloud 30 during the event. The predetermined criteria may be motion associated with dancing or jumping so that footage of the user 12 is recorded when they are involved in the effect without them having to make any active decision to instruct specific data to be recorded. The motion sensor 43 may be the motion sensing mechanism provided within a smart phone 40 or may alternatively be an associated unit such as a wristband or clip on sensor which communicates wirelessly with the user personal device 40.

It will be appreciated that whilst FIGS. 1A, B, C and D each feature various combinations of features in the embodiments illustrated within the Figures, the various features of the system 10 may be combined together in any combination of the embodiments within a system 10 and are not mutually exclusive.

In use, once the image recording apparatus 20 is set up at an event venue, it is necessary for a user 12 to make itself known to the system 10. Using their app 42, the user 12 can provide data to the system to indicate that they are at a specific venue. The system 10 is then able to determine the location of a user 12 using any number of location determining systems. In this embodiment, the location determining system uses a camera flash light 46 of user device 40.

A unique code signal can be allocated to each user of the system, either as a unique code for use at that specific event, or unique and permanent code associated with the user. The flashes can take the form of a serial data stream sent at 15 bit/s, in effect a flash rate of 15 Hz for a camera with a frame rate of 30 fps for example.

An example of such a code is shown in FIG. 2. To transmit one and zero bits of the code, the app 42 will instruct the light 46 to flash in a particular manner, for example once for a one bit or twice for a zero bit within a fixed time interval appropriate for the frame rate of the cameras 22. In the code of FIG. 2, timing is used to distinguish between a zero bit and a one bit with each transmission of the LED flash, from on to off, and off to on, generating a new bit. Transmission in this manner is efficient using a low data rate whilst ensuring that no transmission time is wasted. However, it will be appreciated that any suitable encoding technique could be used. Using a technique of active transmission such as this is a more reliable technique for use when attempting a visual lock onto a signal within a two dimensional image than a technique in which zero bits are represented simply by the light being switched off and not flashing.

To further increase the effectiveness of identification of the unique code, the code can be created as a cyclically unique code, as well as being unique in its singular usage within the event environment. A cyclically unique code means that the code can be transmitted repeatedly on a loop by the device 40 without the need for gaps to be inserted between each transmission of the code. Use of a cyclically unique code means will reduce the time taken for the recording mechanism 20 to identify the code and thus reduce the time a user has to hold their device 40 in a position for the light 46 to be visible.

The user interface app 42 will request that the user confirm that the locating process is to be undertaken. Upon agreement to this confirmation request by the user, the app 42 will instruct the user 12 to hold their user device 40 in a visible position such that it can be activated to issue a unique code signal of flashes. In addition, the app 42 will instruct the system 10 to proceed with the locating process and will request a unique code from the cloud 30. The cloud 30 will issue the next available code to the user device. If the code is an event specific code, data to determine the event venue will have been provided to the cloud either automatically from GPS data or upon input by the user. The cloud 30 will also instruct the location determining mechanism 26 of image recording mechanism 20 located at the event that a new location code has be issued at the event.

The user interface app 42 will then command the user device 12 to flash the appropriate code using the device LED 46.

If, after a predetermined time, for example ten seconds, the code has not been identified by an image recording mechanism 20, the processor 24 will provide this data to the cloud 30. If no camera 22 has recorded image data which includes the code, the location determining mechanism 26 will instruct the image recording mechanism 20 to inform the cloud 30 that it has not identified the code. The cloud 30 will then send data to the user interface app 42 to inform the user of this. The user 12 may choose to try again either with the same code or by requesting a new code.

When a camera 22 has the user 12 in their field of view and so records the flashes of the user device light 46, the code will be identified by location determining mechanism 26 and receipt of the code data will be provided to the cloud 30. The user 12 will be informed that they have been successfully located and the app 42 will cease the signal flashing. Analysis of the image data by the location determining mechanism 26 and local processor 24 will use the unique code signal data to then determine the location of the user within the appropriate camera field of view and ensure accurate footage of the user is obtained.

If there is a limit to the number of code signals available, upon identification of a user using a unique code signal, the code signal may then be recycled for use by unidentified users even if they are at the same event.

Once the user 12 is identified by the system 10 and the image recording apparatus 20 is arranged such that a camera 22 will capture image data of a user 12 whilst they are participating in, or attending, an event. The appropriate camera 22 will provide the image data recorded to the processor 24 where marker data can be applied, for example, location data using information provided by location mechanism 26 or other marker data such as time information can be applied by control unit 28. The processor 24 may further act upon the image data to extract the data, or crop, the image, using location data such that only the image data relevant to a user 12 is provided to cloud 30.

The image data is then stored in the memory 32 of the cloud 30 and upon request by a user 12, a preview of the image data is provided to the user device 40. The preview image data provided to the user device 40 by the cloud 30 can be provided with a low resolution thus enabling the user 12 to require limited use of their cellular data stream to download the preview of the video.

The user 12 can then choose to purchase the image data relevant to them along with any additional data or data modifications which they may wish applied to their image data. Using an actuation mechanism 44, in this case an in app payment mechanism which resides in the user device app 42, the user purchases the image data. Any suitable in-app payment method known in the art could be used to enable quick and secure payment.

Upon purchase, the user determines that the footage should be made available to one or more of their social media profiles such as an external social media interface 50, for example, Facebook, Twitter or Instagram or a system social media platform 47.

The purchased image data is then provided directly from the cloud 30 to a social media platform 50 from where the user can view the full video and share it with their friends. In uploading the image data to a social media platform 50 from the cloud 30, the image data system 10 will utilise an internet connection with suitable bandwidth.

The image data system 10 can be set up and used to record user footage at a variety of events such as arena based events, an example of such system set up is illustrated in FIG. 3 wherein a football stadium 60 is provided with an image recording apparatus 20 having a hub 21 and eleven cameras 22 distributed around the stadium. Cameras 22 are each in wireless communication with the hub 21. Such an arrangement of cameras 22 enables all audience areas to be covered by the images recorded by at least one camera 22. Upon installation of the system 10 at a venue, the system commissioner 14 can input to operation mechanism 34, via web interface 38, any necessary stadium or event data. This stadium or event data then can be provided to the hub 21 of the image apparatus 20 for use if required.

The user 12 can, through their user device operation interface 42 indicate that they wish to receive image data relating to their reaction when any goals are scored in the match. The user 12 can also determine whether they wish their personal image data to have, incorporated within it, image data from the event which they are attending, for example, video footage of a goal being scored which could be placed before the video footage of the user reaction. The user 12 will then have their location within the stadium identified, either by actively providing location data, such as their seat number, to the system 10 or by having their location identified using a unique code flash system using their user device 40 as described with reference to FIG. 2.

Upon receipt of instruction from a user, the image data system 10 will ensure that at least one camera 22 is recording image data from the area the user is in and, in this case, cameras 22a and 22b would be recording the area in which the user 12 is seated and will ensure that image data of the appropriate location is obtained. The processor 24 can act on the location data provided by location determining mechanism 26 in combination with location data provided by the user, or the cloud 30 can provide instruction based on the user location data, to ensure that the recorded field of view frame is edited, cropped, to provide only the portion of the image relating to the user. This reduces the bandwidth required to upload a user's image data to the cloud 30.

A low resolution preview of the video can then be delivered to the user device interface 42 using their mobile phone data facility. The user 12 can then, using their image data system app 42 determine if they wish to obtain the footage recorded and, as detailed broadly above, purchase the footage and have this provided to a social media profile or to an email system or the like.

Should multiple users request a video at the same time, processor 24 can upload multiple cropped user video files to the cloud 30 simultaneously so far as the available bandwidth allows.

In situations where multiple user videos have been requested simultaneously from one image recording mechanism 20, the user videos from multiple cameras 22 may be combined by processor 24 into a larger frame, in essence a “patchwork” to reduce the number of simultaneous file transfers occurring between mechanism 20 and the cloud 30. The cloud operating mechanism 34 would then separate the “patchwork” into several separate files for onward dispatch to an external social media platform 50 or internal social media platform 47.

The request for video footage by the user 12 can be managed by the image data system 10 in one of several ways.

In one embodiment, the user 12 can request a short video, in the order of 6 to 15 seconds for example, during the event using their mobile device app 42. The video footage will be created immediately, in real time, using image data from the cameras 22a and 22b which is streamed to processor 24. The processor 24 can determine how much image data is uploaded to cloud 30 based on the length of video requested by the user thus limiting the bandwidth used to upload the image data from the processor 24 to the cloud 30. The user 12 can select whether they wish the video being created to include simultaneous real time image data from the event they are attending and, if that is the case, operating mechanism 34 can incorporate footage obtained from cameras (not shown) which are recording the event. A low resolution preview of the video can then be delivered to the user device interface 42 using their mobile phone data facility. If the user 12 approves of the preview provided, they can immediately purchase the full video using the actuation mechanism 44 and select to have the video data uploaded from the cloud 30 to at least one of their internal or external social media profiles.

In another embodiment, the image recording apparatus 20 retains a buffer of image data for a short period of time, for example up to five minutes. This buffer of image data enables a user 12 to request video footage of their action and response relating to a key, but unexpected or unpredicted, moment occurring in the event, for example a goal in a football game. Alternatively, the buffered video of key moments can be generated automatically by the system 10 upon provision of a data feed, for example from a sports match scoring system, which is input via interface 38. The command mechanism 34 can instruct the local process 24 to provide buffered footage for the time period desired and for one or more users and this footage can then be offered by the cloud 30 to the user 12 by way of a notification from the user app 42. The user 12 can also select whether they wish the video being created to include footage of the key moment itself to be incorporated into their video and, if that is the case, processor 36 can incorporate buffered footage obtained from cameras (not shown) which are recording the event itself.

In another embodiment, footage recorded by the cameras 22 during the event can be recorded and stored, unedited, in memory 32 of cloud 30. This stored image data will be provided with location and data markers applied in the image recording apparatus 20. The data will can be stored for a suitable duration, for example, say up to a week. Users will be able to purchase, via mechanism 44 of interface 42, extended footage of themselves at the event during the period which the data is stored. The user 12 can also select whether they wish the video being created to include footage of the event itself to be incorporated into their video and, if that is the case, processor 36 can incorporate stored footage obtained from cameras (not shown) which are recording the event itself.

In another embodiment, the user can activate the motion sensor system 43, which typically uses data output from an accelerometer embedded within a user smartphone. The user activates the sensor system 43 using interface app 42. The motion sensor system 43 can then monitor the motion sensors within the user device 40 and provide a data output to indicate when a predetermined motion type is occurring. When a predetermined motion is detected by the user device 40, such as a pattern of movement which corresponds with the user 12 is dancing, or jumping, instruction can be sent to the cloud 30 either in real time, or subsequent to the event, to direct the image record mechanism 20 to obtain footage of the user 12 at the time when they are in motion. The motion sensor system 43 enables footage of the user engaging in the event to be obtained without the users having to request such footage in real time or after the event. The relevant footage can subsequently be offered to the user 12.

In each of the above detailed embodiments, should friends of the user also be attending the event, a user 12, is able to, via interface 42, request that a video combining image data relating to more than one user, so the user and their friends. The video of combined user data can select from the interface 42 whether they wish to have different user images arranged in sequence or whether they wish to have the image data combined into a single frame for example as a picture-in-picture frame.

The system operating mechanism 34 can communicate with the internal social media platform 47 or an external social media platform 50 to aid in identifying any friends of the user 12 who are also attending the same event and thus facilitate the creation of a multi-user video. Similarly, by using social media to determine which friends of the user 12 have posted video content relating to the activity users 12 can be informed by app 42 that their friends have video footage to view.

In another embodiment, the user may be sitting with a group of friends or family that they wish to have included in the edited footage created by the image recording mechanism. The user device app 42 enables such editing of the footage to be undertaken by the user prior to recording. This option can be provided by the app 42 automatically or upon request by the user. To enable the field of view being recorded by the camera to be edited, the system 10 provides the user device 30 with an image of the camera field of view in which their location is situated. The user can then use their device interface, for example the touch screen interface (not shown) of their device 40 to pan and/or zoom the image so that the field of view of the recorded footage can be exactly as they wish. The field of view data is provided by the app 42 to the cloud 30 where command data is issued to the image recording mechanism 20 to ensure appropriate footage is obtained for the remainder of the event. The data provided by the user can be complemented by including information on the number of attendees in their party at the event.

The image data system 10 can also be set up and used to record footage of a user participating in an event where a predictable path will be being followed for at least a part of the activity. An example of such system set up is illustrated in FIG. 4 wherein a user 12 is attempting a ski jump from ski slope 62. In this case there is provided an image recording system 20 which is provided with two cameras 22 which are positioned such that they will record footage of the user 12 skiing down slope 62 and lifting off from the end of the jump 64. The cameras 22 are locally connected with the hub 21 of image recording system 20 via a cable 23 such as an Ethernet cable.

It will be understood that in the above embodiment of FIG. 4 the components 22, 24, 26, 28 of the image recording mechanism 20 could be provided with a wireless transmission system (not shown) which enables the recorded image data to be streamed to the other components of the image recording mechanism 20. Similarly each camera 22 could be replaced by a complete single unit housed image recording mechanism 20. It will also be appreciated that whilst only two cameras 22 are shown in this arrangement, any number of cameras 22 could be used, for example they could be positioned at regular intervals down the slope 62 and also one could be positioned beyond the landing spot (not shown) to record the user 12 landing.

The processor 24 will be triggered locally to actuate the recording of image data from the camera 22 when a user 12 is passing through the field of view. In this embodiment the sensor 66 is an infra-red beam which in turn is connected to a contact closure input to the control and command unit 28 of image recording mechanism 20. The skier will actuate the image recording mechanism when passing through the trigger beam 66 on the slope 62. The trigger 66 is connected to control and command unit 28 and this directs the processor 24 to record the image data from cameras 22.

After the activity, the user 12 will be able to purchase, via mechanism 44 of interface 42, footage of themselves undertaking the activity. As detailed above with reference to the embodiment of FIG. 3, a low resolution preview of the video can be delivered to the user device interface 42 using their mobile phone data facility. The user 12 can then, using their image data system app 42, determine if they wish to obtain the footage recorded and, if so, purchase the footage and have this provided directly to a social media profile or to an email system or the like.

By allowing the application 42 to use social media to determine which friends of the user 12 have posted video content relating to the activity, a user 12 can also view footage of their friends participating in that activity.

Whilst the sensor 66 is in this case an infra-red beam which activates a contact closure trigger, other suitable triggers will include a UDP or serial message which is input into mechanism 20. In particular, a UDP message generated by, for example, an RFID tag system, would enable identification of the user 12 passing the field of view in an activity where multiple users were on the field at the same time, for example go-kart racing or mountain biking, thus enabling the captured footage to be efficiently associated with the user in view.

In an arrangement such as a ski jump 62 where multiple cameras 22 are arranged down the slope of the jump 62 (not shown), a trigger 66 could be associated with each of the cameras to ensure the progression of the user past the cameras 22 is recorded. This progression of image data can then be combined to create a cohesive video showing the progression of the user 12 through the event or activity.

In another an event or environment in which a user is likely to move around may be provided with multiple unlinked image recording mechanisms (not shown) each recording a different activity or different part of a course which an event is following. By using identification data and location data to obtain footage of the user at each activity or location, multiple sections of image data footage of the user participating can be generated and combined to create a single video. For example, in a theme park, each theme park ride could be provided with an image recording mechanism 20 having one or more cameras 22. The user video could consist of a collation of each image recording mechanism image data to generate a “story” video of the user attending multiple activities, for example a video containing footage on each of the rides they went on during their visit.

In an embodiment in which a camera 22 is mounted on a moving object (not shown), such as a rollercoaster cart or a mountain bike, the camera 22 can wirelessly stream the data to the image recording mechanism 20 or can store the data remotely until wireless or cabled transmission of the image data is possible.

In each of the above embodiments, location data to determine the position of a user 12 is necessary in order for image data obtained to be cropped so as to be relevant to the user 12.

In FIG. 4, location data is determined by triggering of a contact closure 66 to indicate the user 12 is in the field of view. The provision of the location data can ensure that the image data recorded by the cameras 22 is edited to include only the image data recorded whilst the user was in the field of view.

In the embodiment of FIGS. 1A-D and FIG. 3 the location determining system used has involved the user personal device emitting a light code which is identified by the system 10 to determine the location of the user.

However, it will be appreciated that other location mechanisms may be used in the image data system 10 for arena or venue based systems such as that of FIGS. 1A-D and FIG. 3. Seat numbers or barcodes on tickets can, for example, be used to determine the user's location. The use of seat numbers or barcodes requires user and, in some cases, operator involvement in the determining of the user location.

For example, if a venue based location determining system such as seat numbers or ticket number codes are being used then, once the camera is correctly positioned, the operator 14 will input into the system 10, through interface 38, location information. The location information will define the area within the field of view of the camera 22 in a manner which can be interrogated by the system 10. Image analysis can then be performed by the system 10 to determine location data relating to the field of view of the camera so that specific positions within the field of view can be identified.

The user 12 may then, via their personal user device, provide seat number data to the system 10 to facilitate determining of the user location such that their specific location can be identified. In one example of such an arrangement, in order for a user 12 to enter the seat number the interface app 42 uses GPS data provided by the user operating device 40 to locate the user 12 near the event. The interface app 42 then provides the user 12 with a selection of event options based on their approximate location determined by the GPS. Once the user has selected the event which they are attending, the seat number data can be entered manually to the user device 40 or be obtained by using the user device 40 to scan a barcode or QR code or the like. The seat number of the scan-able code can be printed on the ticket to the event which the user has, or may be printed on the seat on which the user 12 is sitting. The seat location data is then transmitted by interface 42 to the cloud 30.

When a venue such as stadium 60 installs the image data system 10, each camera is assigned to one or more block of seats with the commissioning operator 14 entering data identifying the block or tier within which the seats are located. For a block of seats, the layout is defined by four corners. The operator will click on a seat within the image and provide it with its seat number information, for example, the user will click on a seat and enter the number A1. The system can then analyse an image of the seat layout in order to detect the shapes of the seats in order to assist the user in the precision of selecting a seat and this data is then forwarded onto the appropriate image recording mechanism(s) 20 in order to ensure the mechanism 20 when provided with the seat information input by the user 12, is able to effectively locate a user's position with a field of view.

In an embodiment in which a vehicle (not shown) is used to transport the user, such as a rollercoaster cart, a vehicle tag (not shown) for example a tag such as a barcode or QR code which can be scanned by the user device 40 can be used to provide location data. Location data may also be provided using a near field reader system (not shown) located in the vehicle which communicates with a user device 40 using near field communication for identification and location purposes wherein the device app 42 issues data identifying the user 12 and their location.

The user device app 42 can, in another embodiment illustrated in FIG. 5, be provided with fiducial mark technology which can provide identification and location data relating to the user in an environment where fiducial marks are provided. The area in which the event is occurring, in this case a concert venue 70, fiducial marks 72 can be positioned on a structure. In this concert venue 70, the fiducial marks 72 are arranged on stanchions 74 at the edge of stage 76 where they are in view of the audience. The commissioning operator 14 inputs data, relating to the fiducial marks 72, into the system 10. The location and profile of the fiducial marks 72 is included in the data which is provided to the system 10 for use in location analysis.

Once a user is within the venue for the event, interface application 42 is launched on the user device 40 by the user 12 and the app 42 uses the process detailed above using GPS to locate the user 12 at the event in question. The application interface 42 instructs the user 12 to raise their phone so that the rear facing camera 46 can see the fiducial marks on the stage. The cloud 30 further provides information, to the user, relating to the general location of the fiducial marks 72. The user can see an image of the view their device camera 48 is seeing and this allows the user 12 to aim in the general location of the marks as directed. When the marks 72 are found in the screen view, visual overlay occurs in the image shown by the camera 48 and the app 42 notifies the user 12 that the marks 72 have been found. The user device app 42 then uses image processing technology to perform a location calculation and determine the position of the user 12. Data identifying the user 12 and their calculated position can then be provided by device app 42 to the cloud 30 for further use by the image recording mechanism 20.

In another embodiment illustrated in FIG. 6, an arrangement of at least three audio beacons or speakers 82 can be located around an area 80 covered by an image data system 10, for example at the perimeter of a crowd.

Each audio beacon 82a, b, c can output a known inaudible acoustic signal and a user device app 42 will receive these signals and, using triangulation, the signals can be used to provide location data relating to the user. The different audio signal provided to each speaker is sent from a synchronised playback unit (not shown) so that each audio signal is in phase at the point of transmission. Each different signal consists of an identifying waveform followed by a waveform which encodes a sequence number. The identifying waveform is unique to each speaker 82a, b, c. The sequence number carried by the waveform increases each time the audio signal is transmitted with repeated transmission of the signal occurring continuously. Once a user 12 is within the area 80, interface application 42 is launched on the user device 40 by the user 12 and the app 42 uses the process detailed above using GPS to locate the user 12 at the event in question.

The user device app 42 then requests that the user 12 provides permission for the app 42 to use the microphone 49 of the device 40. If the user 12 provides the app 42 with permission to use the microphone 49, the app 42 is then able to detect the audio signals being emitted within the venue. The app 42 is then able to analyse the audio signals detected, identify the signals being emitted by the speakers 82a, b, c and determine the phase of each signal relative to the other detected signals. Subsequent analysis of the determined signal phase information can be used to provide an accurate location of the user 12 which is provided to the cloud server 34 for provision to the image recording mechanism 20 such that image data is obtained from the appropriate camera 22.

This location detection mechanism is of use in areas where the user is likely to be moving around within the area as an ongoing determination of the user position can occur to ensure accurate location data is provided to the system 10 such that recorded image data of the user 12 is obtained from the relevant camera 22 and therefore is accurate on an ongoing basis.

In another embodiment, presence cells (not shown) such as those commonly used in mobile communication networks can be used to locate a user 12 to within five metres of a given presence cell when the user device 40 negotiates a signal with the presence cell. This location data can then be provided from the presence cell or from the user device 40 to the image data system 10. To determine a user location using presence cells, then once a user is within the venue for the event, interface application 42 is launched on the user device 40 by the user 12 and the app 42 uses the process detailed above using GPS to locate the user 12 at the event in question. The app 42 then asks the user 12 if they are happy to be located using their cellular connection. If the user 12 agrees, the app 42 requests that the user input their mobile phone number into the app 42. Alternatively, the app 42 can create an SMS message containing a unique identification code for the user 12 to send to the image data system 10. The operating mechanism 34 of the cloud 30 requests location data relating to the user from the user's mobile network using the phone number sent from the app 42 as the query. The mobile network server (not shown) issues a reply to the cloud 30 with details of the user location if known. Should the user location then change, the mobile network can notify the operating mechanism 34 of the cloud 30 of the new location data thus enabling the image data system 10 is able to update the user location data and continue to provide the user with relevant footage of them at the event.

In the above embodiments, the system operating mechanism 34 can communicate with an internal social media platform 47 or an external social media platform 50 to aid in identifying any friends of the user 12 who are also attending the same event, or participating in the same activity, or who have participated in the same activity previously. As the metadata detailing location information created by the image data system 10 is crucial to ensuring accurate footage of a user is obtained, this provides certainty that friends are indeed where the image data system location data places them and that the image data is genuine. In this way, the creation of a multi-user video can be enabled.

Similarly, by using social media to determine which friends of the user 12 have posted video content relating to the activity, users 12 can view footage of their friends participating in that activity. In this way, if friends can't get seats together at an event, they can still share their experience of the event with each other in close to real time. Similarly if a friend is unable to attend an event, the can experience the reality of attending vicariously through the footage of their friends whilst they may also be viewing live footage of the event on the television at the same time. The sharing of the footage of the user from the cloud 30 to social media 50 means that the user footage can be made available in real time or close to real time. This is a significant advantage over directly sending footage to a friend using social media or a messaging interface from the user's mobile phone as bandwidth available at events is usually insufficient for successfully streaming video data.

As user data is collected by the image data system 10 through use, external sources such as external third parties 16 can provide event data and advertising of activities which could be relevant to the user through the social media platform 50 by paying to promote friends videos of the advertisers activities or attending the advertisers events such that the user 12 is viewing their friend participating thus personalising the advertising content. The user device app 42 can act to draw attention of the user 12 to this information.

In a further use of the user data for promotional activities, external third parties can also pay to promote users own videos of experiences or events in their time line in order to ignite an interest in the user to attend the event or experience the activity again.

It will be appreciated that the above embodiments refer the system 10 being used to provide image data with reference to specific activities or events, for example a user attending a football match and a user participating in a ski jump. However, it will be understood that these embodiments are described by way of example only and the user may be attending, or participating in, any number of events including but not limited to a live music concert, a theatrical performance, a rollercoaster or other theme park ride, go-carting, a bungee jump or the like.

By utilising the image data system 10, as detailed in any of the above embodiments, the user 12 is able to obtain personalised video or still images showing them enjoying an event whilst still fully being able to enjoy the event without interrupting the flow of their enjoyment to take pictures or videos. In addition, the user 12 can obtain video footage that would otherwise be impossible to obtain because the camera is located at what would otherwise be a restricted area, for example at the base of a bungee jump.

In addition, by using the image data system 10, the user is able to deliver personal videos and images to one or more of their social media profiles using their mobile phones but without having all the image data travel across their cellular data connection or without waiting until they are able to access a Wi-Fi connection. Instead, the full length high resolution video of the user is stored in the image data system cloud 30 and is uploaded to one or more social media sites directly from the cloud 30, using a high bandwidth connection, upon demand by the user 12. Such an arrangement also allows the user 12 to request live streaming of the image data being recorded by the image data system 10 to a social media platform 50 thus bypassing use of the user device data connection for the transmission of the live streamed image data.

Provision of a low resolution, low data preview of the image data enables the user to determine whether they wish to share the full video footage without using a large amount of their cellular data allocation in doing so. The ability to request adapted previews, either a high resolution, very short segment of preview video, or a low resolution full length video can also be available through the user interface 42. Alternatively, the quality of preview provided can be regulated through the device preferences set by the user 12 for their device 40, for example, use of data saving mode.

It will similarly be understood that there can be any number of cameras 22 recording any particular area with the relevant image data for the location of the user 12 being combined to provide one video of the user incorporating image data from a range of different angles and viewpoints. An example of this arrangement could be understood to be a user in a rollercoaster cart (not shown) with a camera arranged to record the users face directly, and one or more cameras arranged along the rollercoaster track to record footage of the user passing the points at which the track cameras are arranged.

The principle advantage of the present invention is that it provides an image data system which can provide a user with access to personal footage of them recorded at their determined location when attending an event or participating in an activity.

A further advantage of the invention is that personal image data can be accurately obtained by using the user personal device to communicate with the image data system and determine the location of the user at which footage is to be recorded.

A yet further advantage of the invention is that it provides an image data system which enables a user to make available and access personalised video data on a social media profile from the image data system cloud based memory storage thus minimizing data consumption relating to the user's personal mobile device.

A yet further advantage of the invention is that image data relating to the user can be combined with corresponding image data relating to friends attending the same event so that a video of the shared experience can be created.

A yet further advantage of the invention is that image data relating to the user can be obtained by the user without the user interrupting their enjoyment of an event to obtain the video footage.

It will be appreciated by those skilled in the art that modifications may be made to the invention herein described without departing from the scope thereof. For example, whilst in the above embodiments each image recording mechanism 20 is provided with a local processor 24 which edits area image data to obtain user location image data, it will be appreciated that the processor implement this editing function may be located in the cloud 30 and the camera 22 may be arranged to wirelessly transmit the image data directly to the cloud 30 for further editing. In addition, in the LED camera flash location identification mechanism discussed above, the user is provided a unique code upon request to the cloud 30. It will be appreciated that a unique code signal can be allocated to each user of the system either as a unique code for use at that specific event, or unique and permanent code associated with the user which can be used by the user at any event they attend.

We claim:

1. An image data system comprising:
at least one image recording apparatus having at least one camera for obtaining image data from an area including at least one location associated with a user;
a remote processor mechanism operable to access the obtained image data and identify at least one portion of image data relevant to the user according to pre-determined criteria;
a storage mechanism operable to store the at least one portion of image data, and
an activation mechanism operable to provide user access to remotely view the at least one section of the image data held in the storage mechanism.

2. An image data system as claimed in claim 1 wherein the image recording apparatus comprises a plurality of cameras.

3. An image data system as claimed in claim 1 comprising a plurality of image recording apparatus.

4. An image data system as claimed in claim 1 wherein the storage mechanism is a remote server system operable to receive the obtained image data from the at least one image recording apparatus.

5. An image data system as claim in claim 1 wherein the system further comprises a control mechanism operable to provide a preview section of the at least one portion of image data to a user device and the preview section of image data contains less data than the at least one portion of image data.

6. An image data system as claimed in claim 1 wherein the at least one portion of image data is provided to the user via a social media interface.

7. An image data system as claimed in claim 1 where the activation mechanism requires user actuation to provide user access to remotely view the at least one section of the image data held in the storage mechanism.

8. An image data system as claimed in claim 7 wherein user actuation comprises the user making a payment which activates the upload of the at least one portion of image data to a social media interface.

9. An image data system as claimed in claim 1 wherein each image recording apparatus comprises at least one local processor mechanism operable to provide obtained image data with one or more data markers.

10. An image data system as claimed in claim 9 wherein the local processor mechanism is operable to receive command data from a user device to edit image data upon identification of a specific data marker.

11. An image data system as claimed in claim 9 wherein the local processor mechanism is operable to receive command data from an external source to activate a camera to record image data.

12. An image data system as claimed in claim 1 wherein the remote processor mechanism is operable to receive command data from a user to edit the image data.

13. An image data system as claimed in claim 11 wherein the external source is selected from a group comprising: an event specific source, a user personal device, a user personal device activation system or a motion sensor.

14. A method of collecting and distributing image data comprising:
recording image data relating to an area;
identifying at least one location within the area associated with a user;
identifying at least one portion of image data relevant to the user using predetermined identification criteria;
storing the at least one portion of image data in a remote storage mechanism, and, upon activation of a predetermined mechanism, providing user access to remotely view the at least one section of the image data held in the storage mechanism.

15. A user device operating mechanism operable to interface with an image data system, the operating mechanism comprising:
a user interface,
a request mechanism operable to send a request to an image data system for image data relevant to the user,
an activation mechanism which enables a user to activate provision of remote access to relevant image data and a display mechanism operable to enable a user to view the remotely access relevant image data.

16. A user device operating mechanism as claimed in claim 15 further comprising a preview mechanism for receiving a portion of the relevant image data for output on the display mechanism.

17. A user device operating mechanism as claimed in claim 15 wherein the operating mechanism is operable to select a social media interface to which the relevant image data is provided and through which the user is able to view the relevant image data.

18. A user device operating mechanism as claimed in claim 15 wherein the operating mechanism further comprises a command mechanism operable to output a command instructing the image data system to record image data of an area incorporating a location relevant to a user.

19. A user device operating mechanism as claimed in claim 15 wherein the operating mechanism further comprises a location determination mechanism operable to provide an image data system with location data to indicate the location of interest to a user.

20. A user device operating mechanism as claimed in claim 19 wherein the location determination mechanism is a visual location system operable to output a light code output from a user personal device camera flash mechanism.
